(19) United States
(12) Patent Application Publication
(10) Pub. No.: US 2001/0055135 A1
(43) Pub. Date: Dec. 27, 2001

(54) Optical network element

(76) Inventor: Rainer Sigloch, Remseck (DE)

Correspondence Address: LAW OFFICES, SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/810,226

(22) Filed: Mar. 19, 2001

(30) Foreign Application Priority Data
Mar. 20, 2000 (DE) 100 13 489.0

(51) Int. Cl. H04J 14/02

(52) U.S. Cl. 359/124; 359/128

(57) ABSTRACT

Future optical WDM networks will require optical network elements capable of extracting and inserting individual wavelengths from/into the multiplex signal or of switching the individual wavelengths. Such an optical network element contains optical receivers and optical transmitters which are designed respectively to receive and transmit a predetermined wavelength and are connected to a space switching matrix which is arranged between the receivers and the transmitters and serves to selectively switch digital signals received in the individual wavelengths.

In an optical network element according to the invention, a further optical transmitter is provided which is likewise connected to the space switching matrix and carries out a reclocking and restructuring of a frame-structured digital signal to be transmitted, so that the multiplex units internested in the transport frames in accordance with a multiplex hierarchy are embedded in fixed columns of restructured frames which do not change from one frame to the next.

### FIELD OF THE INVENTION

The invention relates to an optical network element for switching wavelengths of a wavelength-division-multiplexed signal, with optical receivers and transmitters each designed respectively to receive and transmit a predetermined wavelength, and with a space switching matrix, arranged between the receivers and the transmitters, for selectively switching digital signals contained in the individual wavelengths. The invention further relates to a system comprising an optical network element of this kind and a digital cross-connect which is designed to switch multiplex units multiplexed in a time-division-multiplexed digital signal in accordance with a multiplex hierarchy of a synchronous digital transmission network, and to a digital cross-connect of this kind as such.

### BACKGROUND OF THE INVENTION

To facilitate the transportation of higher bit rates in future optical transmission networks, it is provided that a plurality of digital signals are transported in parallel in different wavelengths in the form of a wavelength-division-multiplexed signal. This technology is known as WDM (wavelength division multiplexing) or DWDM (dense wavelength division multiplexing). Such optical transmission networks require optical network elements such as add/drop multiplexers which can extract individual wavelengths from the multiplex signal and insert individual wavelengths into a multiplex signal, and optical cross-connects which can switch individual wavelengths between different multiplex signals or also within one multiplex signal. A promising means of fulfilling these objectives consists of the splitting of a received multiplex signal into the individual wavelengths, for example by means of and-pass filtering, and the switching thereof via a space switching matrix. For the near future, electrical solutions are being developed in which the optical digital signals contained in the individual wavelengths are converted into electrical digital signals in the receiver, switched by an electric space switching matrix, and reconverted into optical digital signals in transmitters. For the more distant future, work is also underway on a completely optical switching of the digital signals.

In principle, a wavelength can be used to transport a digital signal of arbitrary data content and format, such as IP packets, ATM cells or communications signals structured in accordance with the ITU-T recommendations for SDH and SONET. Current transmission networks are mainly SDH and SONET networks. Therefore the transmission of SDH signals will constitute an important application in future WDM networks. These are time-division-multiplexed, frame-structured communications signals in which virtual containers of different hierarchy levels are multiplexed in accordance with a multiplex hierarchy in a payload region of the transport frames and are addressed by a pointer in the header region of the transport frames. Virtual containers contain the actual useful information to be transmitted together with control information for the transmission path in the network. Virtual containers of sizes VC-12 (VC-11 for SONET), VC-2, VC-3 and VC-4 (only in SDH) are specified as hierarchy levels, smaller containers always being multiplexed in larger containers and addressed by a pointer in the header region of the larger containers. The precise structure of the containers and of the transport frame and the different multiplexing possibilities are described in ITU-T G.707 (3/96). SDH and SONET-networks will be referred to in the following as synchronous transmission networks. Digital signals structured in accordance with ITU-T G.707 will be referred to in the following as synchronous communications signals.

Such synchronous transmission networks require network elements such as add/drop multiplexers which are capable of extracting or inserting individual virtual containers of different hierarchy levels from/into a synchronous communications signal, digital cross-connects which switch transmission paths by cross-connecting virtual containers, and line- and terminal multiplexers which can terminate transmission paths. To ensure that the network elements are compatible with one another and to facilitate signal transmission over a relatively long fibre link, the line interfaces of such network elements must comply with different standardized requirements. Thus it is necessary that the line interfaces should be able to be interrogated and configured via a central management system, that communications signals to be transmitted are scrambled in the line interfaces and received communications signals are correspondingly descrambled in the line interfaces, and that the transmitting lasers are monitored at their output end in respect of function and transmission level.

Further functions can additionally be performed in the line interfaces, such as for example restructuring of received transport frames into an internal frame format. U.S. Pat. No. 5,210,745 has disclosed such restructuring in which the virtual containers contained in the received transport frame are packed into fixed columns of the internal frame which do not change from one frame to the next, whereby pointer justifications in the received communications signal are compensated. This ensures that the space-time switching matrix of the network element, which is supplied with the internal frames, can switch the virtual containers in time-slot-oriented manner.

However, the described functions render line interfaces of the network elements technically complex and costly. Similar applies to the interfaces of the optical network elements.

### SUMMARY OF THE INVENTION

Therefore an object of the present invention is to provide an optical network element for a WDM network with which synchronous communications signals can be transported via the WDM network in a simpler and efficient manner. A further object of the invention is to provide a network element for a synchronous transmission network with which synchronous communications signals can be received from an optical network element of a WDM network in a simpler and efficient manner. A further object of the invention is to provide a system comprising such an optical network element and such a network element for a synchronous transmission network.

These objects are achieved in respect of the optical network element by an optical network element for switching wavelengths of a wavelength-division-multiplexed optical signal comprising:

an optical input for the optical multiplex signal,

a number of optical receivers, each connected to the optical input, for receiving one of the wavelengths contained in the optical multiplex signal,

a number of optical transmitters each for generating an optical digital signal with a wavelength assigned to the transmitter, where the optical transmitters are connected at their output end to a common optical output for a wavelength-division-multiplexed optical output signal,

a space switching matrix, arranged between the optical receivers and the optical transmitters, for selectively switching digital signals, received in the individual wavelengths, between the optical receivers and the optical transmitters and

at least one further optical transmitter, which is likewise connected to the space switching matrix, for generating an optical digital signal, synchronised to a reference clock, with a frame structure which is composed of consecutive transport frames and in which multiplex units are multiplexed in accordance with a multiplex hierarchy in a payload region of each transport frame and are addressed by a pointer in the header region of each transport frame, and where the multiplex units are always embedded in the transport frame such that the pointer value remains unchanged from one transport frame to the next.

In respect of the network element for the synchronous transmission network these objects are achieved by a network element for a synchronous transmission network for switching multiplex units multiplexed in time-division-multiplexed optical digital signals, wherein the digital signals have a frame structure which consists of consecutive transport frames and in which the multiplex units are multiplexed in accordance with a multiplex hierarchy in a payload region of each transport frame and are addressed by a pointer in the header region of each transport frame comprising:

a number of optical receivers, each for receiving one of the time-division-multiplexed optical digital signals and for generating an internal digital signal, synchronised to a common reference clock, with a frame structure which consists of consecutive restructured frames and in which the multiplex units are embedded in each of the restructured frames such that the pointer value remains unchanged from one frame to the next,

a number of optical transmitters each for generating a frame-structured, time-division-multiplexed optical digital signal to be transmitted,

a space-time switching matrix, arranged between the optical receivers and the optical transmitters, for selectively switching the multiplex units, contained in the internal digital signals, between the optical receivers and the optical transmitters and

at least one opto-electronic converter, which is likewise connected to the space-time switching matrix, for converting a received optical digital signal into an electric digital signal, where an input-end optical terminal of the opto-electric converter leads outwards so that via this terminal the network element can be supplied with an optical digital signal, synchronised to the same common reference clock, with a frame structure which consists of consecutive transport frames, where multiplex units contained therein are embedded in each transport frame such that the pointer value remains unchanged from one transport frame to the next.

In respect of the system these objects are achieved by a system comprising an optical network element for switching wavelengths of a wavelength-division-multiplexed optical signal, and a network element for a synchronous transmission network for switching multiplex units of a time-division-multiplexed synchronous digital signal, wherein the optical network element comprises:

an optical input for the optical multiplex signal,

a number of optical receivers, each connected to the optical input, for receiving one of the wavelengths contained in the optical multiplex signal,

a number of optical transmitters each for generating an optical digital signal with a wavelength assigned to the transmitter, where the optical transmitters are connected at their output end to a common optical output for a wavelength-division-multiplexed optical output signal,

a space switching matrix, arranged between the optical receivers and the optical transmitters, for selectively switching digital signals, received in the individual wavelengths, between the optical receivers and the optical transmitters and

at least one further optical transmitter, which is likewise connected to the space switching matrix, for generating an optical digital signal, synchronised to a reference clock, with a frame structure which consists of consecutive transport frames and in which multiplex units are multiplexed in accordance with a multiplex hierarchy in a payload region of each transport frame and are addressed by a pointer in the header region of each transport frame and where the multiplex units are embedded in the transport frames such that the pointer value remains unchanged from one transport frame to the next, herein the network element for the synchronous transmission network comprises:

a number of optical receivers each for receiving one of the time-division-multiplexed optical digital signals and for generating an internal digital signal synchronised to a common reference clock, with a frame structure which consists of consecutive restructured frames and in which the multiplex units are embedded in each of the restructured frames such that the pointer value remains unchanged from one frame to the next,

a number of optical transmitters each for generating a frame-structured, time-division-multiplexed, optical digital signal to be transmitted,

a space-time switching matrix, arranged between the optical receivers and the optical transmitters, for selectively switching the multiplex units, contained in the internal data signals, between the optical receivers and the optical transmitters and

at least one opto-electric converter, which is likewise connected to the space-time switching matrix, for converting a received optical digital signal into an electric digital signal, where an input-end optical terminal of the opto-electric converter leads outwards so that via this terminal the network element can be supplied with an optical digital signal, synchronised to the same common reference clock, with a frame structure composed of consecutive transport frames, where multiplex units contained therein are embedded in each transport frame such that the pointer value remains unchanged from one transport frame to the next,

and wherein the further optical transmitter of the optical network element is directly connected via an internal optical fibre to the opto-electric converter of the network element for the synchronous transmission network. Advantageous developments are described in the dependent claims.

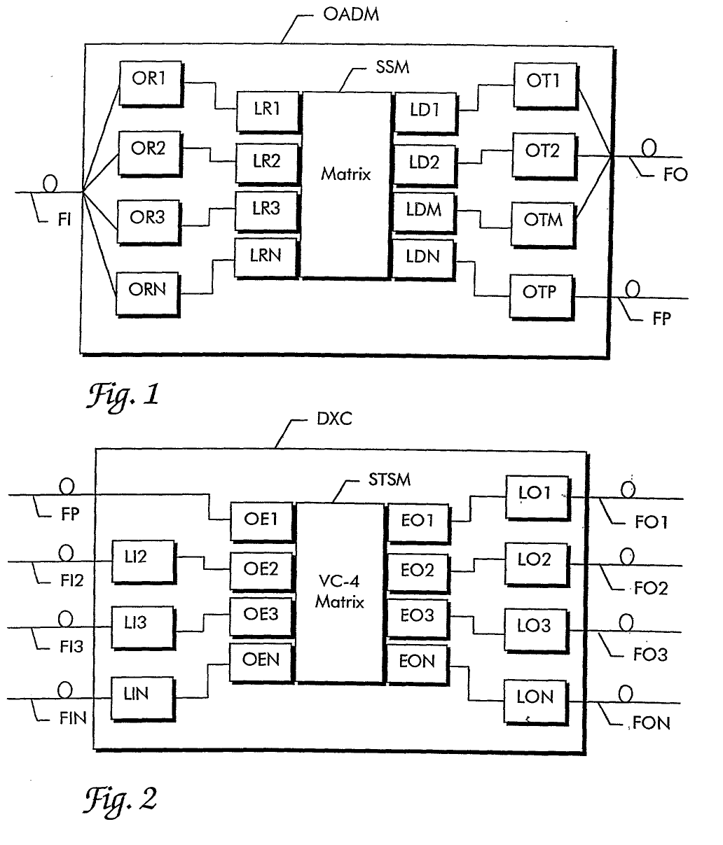

In the following the invention will be explained in the form of several embodiments making reference to FIGS. 1 to 3 wherein:

FIG. 1 illustrates an optical add/drop multiplexer for switching wavelengths of a wavelength-division-multiplexed multiplex signal,

FIG. 2 illustrates a digital cross-connect for a synchronous transmission network for switching multiplex units of a time-slot-multiplexed communications signal and

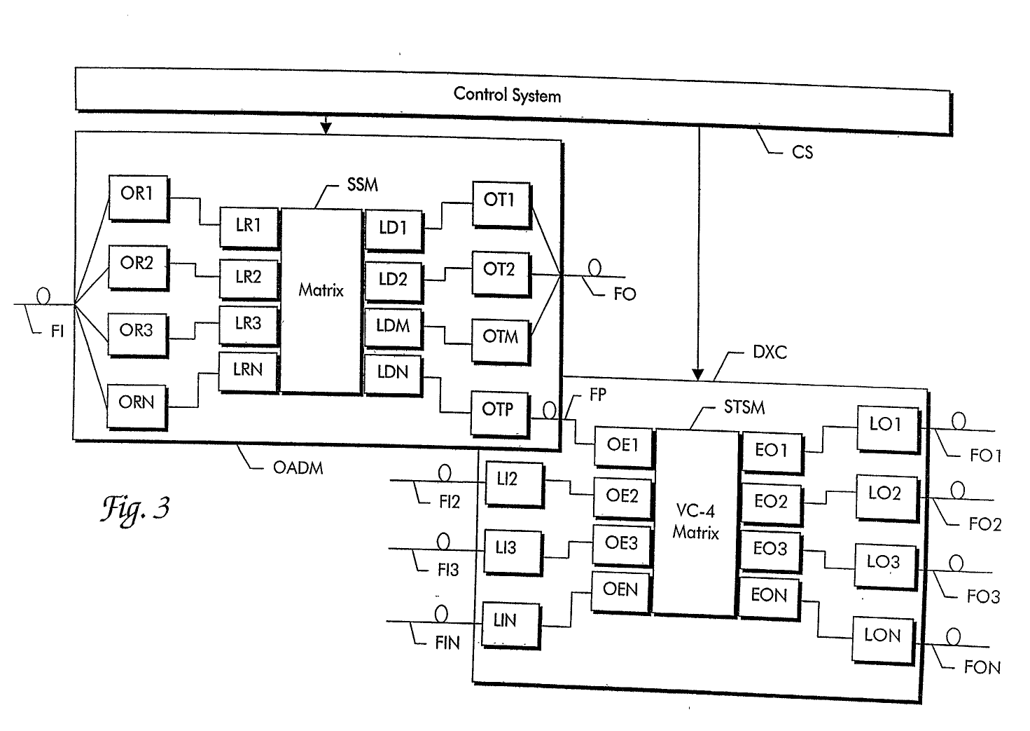

FIG. 3 illustrates a system comprising the optical add/drop multiplexer according to FIG. 1 and the digital cross-connect according to FIG. 2.

### DETAILED DESCRIPTION OF THE INVENTION

In WDM networks arbitrary digital signals are transmitted in transparent manner. For this purpose each signal to be transmitted is allocated one wavelength and the individual wavelengths are wavelength-division-multiplexed to form a multiplex signal. In order that the digital signals to be transported can be flexibly cross-connected in the network, optical network elements are required. The granularity which can be switched by an optical network element of this kind is to be one wavelength. A main application of such WDM networks, at least in the next few years, will consist of the transmission of synchronous communications signals from a synchronous communications network (SDH or SONET).

An electric switching matrix is generally used in optical network elements. If an SDH network element is now to be connected to an optical network element, some functions of the line interface of the SDH network element could actually be performed in the optical network element. However, the large bandwidth of the digital signals to be switched imposes a spatial restriction, i.e. only short distances of a few meters can be bridged by electric lines. Therefore optical network element and SDH network element are optically connected. A basic principle of the invention is that, in the case of a connection between an optical network element and a SDH network element, although the line interface of the SDH network element is logically allocated to the SDH network element, it is physically allocated to the optical network element. It is then possible to use a favourable internal optical interface between the two network elements.

An optical network element can be roughly divided into two main assemblies: The core assembly is a broadband switching matrix, for example for 10 Gbit/sec-signals, together with electrical connecting means such as line driver circuits and line receiver circuits. The second group of assemblies comprises the optical I/O assemblies (I/O: input/output), i.e. optical receivers and optical transmitters.

FIG. 1 illustrates an optical add/drop multiplexer OADM as an exemplary embodiment of an optical network element. This has an optical input which is connected to an optical waveguide via which a wavelength-division-multiplexed optical multiplex signal F1 is received. The optical input is connected via a splitter to a plurality of optical receivers OR1-ORN in each case provided for one wavelength. Each of the optical receivers receives an allocated wavelength and converts an optical digital signal, contained in this wavelength, into an electrical digital signal. At their output end the optical receivers are each electrically connected to a line receiver LR1-LRN. 50 Ohm coaxial cable interfaces are used for the electrical connections.

The OADM also comprises an electric space switching matrix SSM which is used for the selective switching of the received digital signals. The space switching matrix is a N×N, i.e. a switching matrix with N inputs and N outputs. Only four inputs and outputs have been schematically illustrated in FIG. 1, whereas in the exemplary embodiment N=128. Any one of the N inputs can be switched to any one of the N outputs. The line receivers LR1-LRN are connected to the inputs of the space switching matrix SSM. Line drivers LD1-LDN are connected to the outputs of the matrix. The matrix capacity of 128×128 is sufficient for four-fibre rings (one fibre for each direction and one redundant fibre for each direction) with 32 wavelengths per fibre. For other applications such as an optical cross-connect, a larger matrix capacity can also be suitable. The matrix switches the electric digital signals in bit-rate-transparent manner for bit rates between 100 Mbit/sec and 10 Gbit/sec. In the future, higher-speed switching atrices, capable for example of switching digital signals up to 40 Gbit/sec, will undoubtedly also be used for applications which require higher bit rates. The switching matrix also has broadcast capability, i.e. each input can be connected simultaneously to a plurality of outputs so that an input signal can be switched simultaneously to a plurality of outputs (broadcast switching).

Each of the line drivers LD1-LDN is connected to an optical transmitter OT1-OTM, OTP. From the electrical digital signal obtained from the connected line driver, the optical transmitters OT1-OTM in each case generate an optical digital signal with a wavelength assigned to the transmitter. In each of these optical transmitters, the output level of the optical signal is monitored to ensure that the optical signals are transmitted over long fibre links of at least 80 km length. At their output end the optical transmitters OR1-OTM are connected via a coupler to an output of the OADM. This output is connected to an optical waveguide via which a wavelength-division-multiplexed multiplex signal (FO) is transmitted.

Both internally, i.e. in the switching matrix, and externally, i.e. in the transmitters and receivers, a performance monitoring takes place based on the known FEC process (FEC: forward error correction).

Via the line driver LDN a further optical transmitter OTP is connected to the switching matrix SSM. This further optical transmitter OTP is designed for synchronous communications signals and performs functions typical of a line interface of a SDH network element. In particular, the transmitter reclocks the synchronous communications signal to a reference clock and restructures the transport frames contained in the communications signal. Here multiplex units, which are internested in the payload region of each transport frame in accordance with the SDH multiplex hierarchy and are addressed by a pointer in the header region of each transport frame, are always embedded in the restructured transport frames such that the pointer value remains unchanged from one transport frame to the next. This serves to compensate pointer justifications, which are typically performed in synchronous transmission networks, for correcting clock differences of the network elements of the transmission network.

A proprietary frame format, also employed as internal frame format in SDH network elements, is used for the restructured frames. Therefore an identifier is attached to the communications signal, as well as check bits facilitating error checking. Then, by means of a simple laser diode without level monitoring, the thus generated, restructured communications signal is transmitted as optical digital signal via another connected fibre to another output of the optical OADM. As a non-standard signal format is transmitted, this further transmitter OTP is a proprietary output.

FIG. 2 illustrates a digital cross-connect DXC as an exemplary embodiment of a network element of a synchronous transmission network. The DXC has a plurality of optical receivers L12-L1N, a plurality of optical transmitters LO1-LON and a space-time switching matrix STSM. The space-time switching matrix STSM is a N×N matrix with N inputs and N outputs. Preferably the switching matrix STMS can have the form of a three-stage Clos matrix. Opto-electronic converters OE1-OEN are connected to the inputs of the switching matrix STSM, and the outputs of the switching matrix STSM are connected to electro-optical converters EO1-EON. Together with the converters the matrix represents a modular unit which is switched with interface modules such as transmitters and receivers via simple internal optical connections. The matrix itself preferably is likewise of modular construction and therefore easily expandable.

The DXC is therefore of modular construction in respect of the matrix and interfaces, i.e. the transmitter and receiver circuits, and therefore can easily be expanded. The functionality of the DXC is highly dependent upon the functionality made available by the interface circuits. The individual modules are connected by internal optical connections with a length of up to 200 m. The switching matrix has a switching capacity of 2000 STM-1 equivalents, but can be expanded to a switching capacity of up to 16,000 STM-1 equivalents. The configuration of matrix and interface circuits is software-controlled.

The receivers L12-L1N are each connected to an optical waveguide via which synchronous communications signals F12-F1N are received from the synchronous communications network to which the DXC is connected. The communications signals F12-F1N are time-division-multiplexed, optical, digital signals and have a frame structure which consists of consecutive transport frames and in which multiplex units of different sizes are multiplexed in accordance with a multiplex hierarchy in a payload region of each transport frame. The multiplex units are referred to as virtual containers and contain the useful information which is actually to be transmitted as well as control information for the transmission path in the network. Virtual containers of the sizes VC-12 (VC-11 for SONET), VC-2, VC-3 and VC-4 (only in SDH) are specified as hierarchy levels, smaller containers always being multiplexed in larger containers and addressed by a pointer in the header region of the larger containers. The largest virtual container (VC-4 in the case of SDH, in each case three VC-3s in the case of SONET) is addressed by a pointer in the header region of each transport frame.

Each of the receivers L12-L1N serves as a receiving-end line interface to the synchronous communications network and performs standardized functions, such as the descrambling of the received communications signals F12-F1N, and control- and configuration functions at the request of a central management system. Additionally a restructuring of the received transport frames into an internal frame format is performed in each receiver. For this purpose, the received communications signals are reclocked to an internal reference clock and the virtual containers contained in the received transport frames are packed into fixed columns of a new internal frame which do not change from one frame to the next. This also means that no change occurs in the pointer value of the pointer in the frame header of the restructured frames from one frame to the next. Each of the receivers LR1-LRN is connected to one of the opto-electronic converters OE2-OEN via an internal optical connection, which in the exemplary embodiment is to be no longer than 200 m, and via this connection transmits the restructured synchronous communications signals in the internal frame format to the switching matrix STSM.

At its output end the switching matrix STSM is connected to the optical transmitters LO1-LON. For this purpose each of the electro-optical converters EO1-EON is in each case connected via an internal optical connection to one of the optical transmitters LO1-LON. Each of the transmitters LO1-LON serves as a transmitting-end line interface into the synchronous communications network and, in the same way as the receiving-end line interfaces, performs standardized functions, such as the scrambling of the communications signals FO1-FON to be transmitted, and control- and configuration functions at the request of the central management system. In the transmitting-end line interfaces the digital signals received by the switching matrix STSM, which are structured in the internal frame format, are converted into the frame format prescribed for SDH. The optical transmitters LO1-LON are each connected to an optical waveguide via which the thus converted digital signals FO1-FON are transmitted into the synchronous transmission network.

The DXC is provided with a further input which is not connected to an optical receiver of the above described type but is directly connected to one of the opto-electronic converters OE1. An optical fibre is connected to this input, via which optical fibre an already restructured, synchronous communications signal FP is received from another network element. For this purpose, the input-end terminal of the opto-electrical converter OE1 is connected as input to the exterior of the DXC so that via this input the DXC can be supplied with the optical communications signal FP already synchronised to the same internal reference clock. The communications signal FP has a frame structure which consists of consecutive transport frames, where the virtual containers internested in the frames are embedded in fixed columns of each transport frame, i.e. columns which remain the same from one frame to the next, and the pointer value thus remains unchanged from one transport frame to the next. As a non-standard signal format is expected, this further input is a proprietary input.

FIG. 3 illustrates the cooperation of the optical add/drop multiplexer OADM in FIG. 1 and of the digital cross-connect DXC in FIG. 2. The proprietary output OTP of the OADM is connected to the opto-electronic converter OE1, i.e. the proprietary input, of the DXC via a simple optical fibre. As the communications signal FP, which is transmitted via this fibre from the OADM to the DXC, is already synchronised to the internal clock of the DXC and restructured in order to compensate pointer justifications, the communications signal can be used directly, without preprocessing, as input signal for the switching matrix STSM of the DXC. All the functions of a line interface which must be performed in the DXC are already implemented at the transmitting end in the OADM. For this purpose both network elements OADM and DXC are connected to the central management system CS of the synchronous transmission network.

To facilitate the reclocking of the communications signal FP in the transmitting-end interface OTP of the OADM, a clock connection not shown in FIG. 3 extends between the network elements, for example via a 2 MHZ interface of the two devices. Thus the interface OTP of the OADM is supplied with a reference clock by the DXC. The interface OTP is thus synchronised to the reference clock of the DXC, while the other outputs of the OADM are synchronised to an intrinsic clock—generally the clock of the input signal which is switched to the relevant output via the space switching matrix SSM. Consequently the interface OTP of the OADM is coordinated with the DXC both logically and in terms of synchronisation.

FIG. 3 illustrates the interconnection of the OADM according to the invention and the DXC. Advantageously, the two network elements can also be combined to form one system and commonly installed. In particular, the system can also consist of one single network element in which the OADM and the DXC are integrated. Thus this integrated network element can be equipped with a common power supply, a common control terminal and a common control computer. The integrated network element can also be constructed as a modular system composed of sub-components such as interface cards and matrix modules and installed in a common rack.

1. An optical network element for switching wavelengths of a wavelength-division-multiplexed optical signal comprising:
an optical input for the optical multiplex signal,
a number of optical receivers, each connected to the optical input, for receiving one of the wavelengths contained in the optical multiplex signal,
a number of optical transmitters each for generating an optical digital signal with a wavelength assigned to the transmitter, where the optical transmitters are connected at their output end to a common optical output for a wavelength-division-multiplexed optical output signal,
a space switching matrix, arranged between the optical receivers and the optical transmitters, for selectively switching digital signals, received in the individual wavelengths, between the optical receivers and the optical transmitters and
at least one further optical transmitter, which is likewise connected to the space switching matrix, for generating an optical digital signal, synchronised to a reference clock, with a frame structure which is composed of consecutive transport frames and in which multiplex units are multiplexed in accordance with a multiplex hierarchy in a payload region of each transport frame and are addressed by a pointer in the header region of each transport frame, and where the multiplex units are always embedded in the transport frame such that the pointer value remains unchanged from one transport frame to the next.

2. An optical network element according to claim 1, wherein
the optical receivers are designed to convert an optical digital signal, contained in the wavelength respectively allocated to them, into an electrical digital signal,
each of the optical receivers is electrically connected to a line receiver,
a number of electric line drivers are provided which are in each case connected to one of the optical transmitters and
the space switching matrix has the form of an electric N×N space switching matrix and is arranged between the electric line receivers and the electric line drivers.

3. An optical network element according to claim 1 which has the form of an optical add/drop multiplexer for a 4-fibre ring.

4. An optical network element according to claim 1 which has the form of an optical cross-connect.

5. An optical network element according to claim 1, wherein the further optical transmitter is designed to perform the functions of a line interface of a network element for a synchronous digital communications transmission network.

6. A network element for a synchronous transmission network for switching multiplex units multiplexed in time-division-multiplexed optical digital signals, wherein the digital signals have a frame structure which consists of consecutive transport frames and in which the multiplex units are multiplexed in accordance with a multiplex hierarchy in a payload region of each transport frame and are addressed by a pointer in the header region of each transport frame comprising:
a number of optical receivers, each for receiving one of the time-division-multiplexed optical digital signals and for generating an internal digital signal, synchronised to a common reference clock, with a frame structure which consists of consecutive restructured frames and in which the multiplex units are embedded in each of the restructured frames such that the pointer value remains unchanged from one frame to the next,
a number of optical transmitters each for generating a frame-structured, time-division-multiplexed optical digital signal to be transmitted,
a space-time switching matrix, arranged between the optical receivers and the optical transmitters, for selectively switching the multiplex units, contained in the internal digital signals, between the optical receivers and the optical transmitters and
at least one opto-electronic converter, which is likewise connected to the space-time switching matrix, for converting a received optical digital signal into an electric digital signal, where an input-end optical terminal of the opto-electric converter leads outwards so that via this terminal the network element can be supplied with an optical digital signal, synchronised to the same common reference clock, with a frame structure which consists of consecutive transport frames, where multiplex units contained therein are embedded in each transport frame such that the pointer value remains unchanged from one transport frame to the next.

7. A network element according to claim 6, wherein the optical receivers are connected at their output end to further opto-electronic converters via internal optical fibres, and the optical transmitters are connected at their input end to electro-optical converters likewise via internal optical fibres, and wherein the space-time switching matrix is arranged between the opto-electronic converters and the electro-optical converters.

8. A network element according to claim 6 which has the form of a digital cross-connect.

9. A system comprising an optical network element for switching wavelengths of a wavelength-division-multiplexed optical signal, and a network element for a synchronous transmission network for switching multiplex units of a time-division-multiplexed synchronous digital signal, wherein the optical network element comprises:
an optical input for the optical multiplex signal,
a number of optical receivers, each connected to the optical input, for receiving one of the wavelengths contained in the optical multiplex signal,
a number of optical transmitters each for generating an optical digital signal with a wavelength assigned to the transmitter, where the optical transmitters are connected at their output end to a common optical output for a wavelength-division-multiplexed optical output signal,
a space switching matrix, arranged between the optical receivers and the optical transmitters, for selectively switching digital signals, received in the individual wavelengths, between the optical receivers and the optical transmitters and
at least one further optical transmitter, which is likewise connected to the space switching matrix, for generating an optical digital signal, synchronised to a reference clock, with a frame structure which consists of consecutive transport frames and in which multiplex units are multiplexed in accordance with a multiplex hierarchy in a payload region of each transport frame and are addressed by a pointer in the header region of each transport frame and where the multiplex units are embedded in the transport frames such that the pointer value remains unchanged from one transport frame to the next,
wherein the network element for the synchronous transmission network comprises:
a number of optical receivers each for receiving one of the time-division-multiplexed optical digital signals and for generating an internal digital signal synchronised to a common reference clock, with a frame structure which consists of consecutive restructured frames and in which the multiplex units are embedded in each of the restructured frames such that the pointer value remains unchanged from one frame to the next,
a number of optical transmitters each for generating a frame-structured, time-division-multiplexed, optical digital signal to be transmitted,
a space-time switching matrix, arranged between the optical receivers and the optical transmitters, for selectively switching the multiplex units, contained in the internal data signals, between the optical receivers and the optical transmitters and
at least one opto-electric converter, which is likewise connected to the space-time switching matrix, for converting a received optical digital signal into an electric digital signal, where an input-end optical terminal of the opto-electric converter leads outwards so that via this terminal the network element can be supplied with an optical digital signal, synchronised to the same common reference clock, with a frame structure composed of consecutive transport frames, where multiplex units contained therein are embedded in each transport frame such that the pointer value remains unchanged from one transport frame to the next,
and wherein the further optical transmitter of the optical network element is directly connected via an internal optical fibre to the opto-electric converter of the network element for the synchronous transmission network.

10. A system according to claim 9, wherein the two network elements are connected to a central network management system of the synchronous transmission network.

11. A system according to claim 9, wherein the two network elements are connected to one another by a clock line, and the network element for the synchronous transmission network supplies the optical network element with the reference clock.

12. A system according to claim 9 which has the form of one single network element and has a common power supply, a common control terminal and a common control computer.

13. A system according to claim 12 which is constructed as a modular system composed of subsidiary components such as interface cards and matrix modules and is installed in a common rack.
